(19) United States
(12) Patent Application Publication
(10) Pub. No.: US 2006/0083187 A1
(43) Pub. Date: Apr. 20, 2006

(54) Pairing system and method for wirelessly connecting communication devices

(75) Inventor: Aviv Dekel, St. Raanana (IL)

Correspondence Address: F. JASON FAR-HADIAN;CENTURY IP LAW GROUP, PO BOX 7333, NEWPORT BEACH, CA, 92658-7333, US

(73) Assignee: Mobile (R&D) Ltd.

(21) Appl. No.: 10/968,682

(22) Filed: Oct. 18, 2004

(51) Int. Cl. H04B 7/00

(52) U.S. Cl. 370/310

(57) ABSTRACT

A method for establishing a communication connection with a target device over a short-range wireless communication protocol is provided. The method comprises initiating a pairing request for connecting to the target device, the pairing request comprising a first wireless device address associated with a requesting device; and forwarding the pairing request to a destination address associated with the target device over a wide area network, requesting a second wireless device address associated with the target device.

### BACKGROUND

### Field of Invention

The present invention relates generally to communications between computing devices and, more particularly, to a system and method for pairing multiple wireless communication devices.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

### RELATED ART

Wireless communication technology and wireless communication devices continue to grow in popularity as the related systems and accessories become more affordable and easier to use. A recent trend in wireless communication involves implementation of personal area networks (PAN) for connecting mobile communication devices or other computing systems to each other, using efficient and cost-effective wireless technologies such as Bluetooth™ or Wi-Fi™.

For example, some recently developed wireless mobile communication devices (e.g., Sony Ericsson P800, 3G Motorola A830, Siemens S55, Nokia 6310i) include a Bluetooth interface that enables the devices to wirelessly communicate with one another or another wireless device (e.g., a wireless earpiece). Each device, typically, will need to include a wireless communication port compatible with the Bluetooth technology so that a communication connection can be established between the devices.

Several steps precede the successful establishment of a Bluetooth connection between two devices. Referring to FIG. 1A, in a related art method, in step 1, at least one device enters a discover mode. In this mode, the device will broadcast a signal with information about itself and that it is available for connection. Every Bluetooth device within 30 feet (i.e., 10 meters) that is available for connection should respond to the broadcasted signal.

In step 2, the device switches to a search mode to find another compatible wireless device in its range that has responded to the broadcasted signal. In step 3, the broadcasting device is paired with one or more responding devices according to pairing information communicated in the broadcast and respond signals. Pairing information includes addressing and authentication information such as a unique device address and a personal identification number (PIN).

Exchange of a unique device address and PIN provides a method of authentication and prevents data from being intercepted by an unauthorized (i.e., unpaired) device. As such, a secured communication channel can be maintained between the paired devices. In step 4, if pairing is successful then the devices are connected for communication.

Unfortunately, the pairing and connecting processes are rather cumbersome. That is, for one or more devices to be successfully paired and connected, a user will have to go through a series of steps including executing one or more software applications to initiate the connection and provide the requisite PIN numbers, authentication codes or device addresses.

Providing or remembering addressing and authentication codes are typically inconvenient. For example, a Bluetooth device address (BD_ADDR) is a unique 48 bit device address divided into a 24 bit LAP (Lower Address Part), a 16 bit NAP (Non-significant Address Part) and an 8 bit UAP (Upper Address Part). A user may have a difficult time remembering or entering the device address, particularly if more than one device is being paired.

As such, more convenient systems and methods for pairing and connecting wireless devices are needed.

### SUMMARY

The present disclosure is directed to a system and corresponding methods for pairing multiple communication devices to communicate in a wireless environment.

For purposes of summarizing, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested.

In accordance with one aspect of the invention, a method for pairing multiple wireless communication devices is provided. The method comprises initiating a pairing request for connecting to the target device, the pairing request comprising a unique identification code and a first wireless device address associated with a requesting device; and forwarding the pairing request in form of a first text message to a phone number associated with the target device over a wide area network, requesting a second wireless device address associated with the target device as authenticated by the unique identification code.

In one embodiment, the method further comprises authenticating a pairing response sent from the target device in form of a second text message to a phone number associated with the requesting device, based on the unique identification code; or retrieving the second wireless device address from the text message, if authentication is successful.

In a preferred embodiment, the first and second text messages are forwarded over a short messaging service (SMS) protocol. In another embodiment, a communication server manages delivery of the pairing request to the target device and the pairing response to the requesting device.

A connection is established with the target device over the short-range wireless protocol based on the unique identification code and the first and second wireless device addresses. The short-range wireless protocol comprises Bluetooth communication protocol or IEEE 802.11 communication protocol, in one or more embodiments of the invention.

In accordance with another aspect of the invention, a system for establishing a communication connection with a target device over a short-range wireless communication protocol is provided. The system comprises circuitry for initiating a pairing request for connecting to the target device, the pairing request comprising a unique identification code and a first wireless device address associated with a requesting device; and circuitry for forwarding the pairing request in form of a first text message to a phone number associated with the target device over a wide area network, requesting a second wireless device address associated with the target device as authenticated by the unique identification code.

The system may further comprise circuitry for authenticating a pairing response sent from the target device in form of a second text message to a phone number associated with the requesting device, based on the unique identification code. In one embodiment, the system may also comprise circuitry for retrieving the second wireless device address from the text message, if authentication is successful.

In some embodiments, the first and second text messages are forwarded over a short messaging service (SMS) protocol, for example. Further, a communication server manages delivery of the pairing request to the target device and the pairing response to the requesting device.

In yet another embodiment, a method for establishing a communication connection with a target device over a short-range wireless communication protocol is provided. The method comprises initiating a pairing request for connecting to the target device, the pairing request comprising a first wireless device address associated with a requesting device; and forwarding the pairing request to a destination address associated with the target device over a wide area network, requesting a second wireless device address associated with the target device.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

Embodiments of the present invention are understood by referring to the figures in the attached drawings, as provided below.

FIG. 1A illustrates a related art method for wirelessly connecting two communication devices;

FIG. 1B illustrates an exemplary wireless communication environment, in accordance with one embodiment of the invention;

FIG. 2 is a flow diagram of an exemplary method of pairing devices in a wireless communication environment, in accordance with one or more embodiments;

FIG. 3 is a flow diagram of another exemplary method of pairing devices in a wireless communication environment, in accordance with another embodiment; and

FIGS. 4A and 4B are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION

A computing system and corresponding computer executable methods, according to an embodiment of the present invention, facilitate and provide a pairing system for connecting multiple wireless communication devices in a personal area network (PAN). A PAN is a close-range network in which multiple devices can communicate with one another as soon as a device is situated within the proximate range of another device. The devices in the PAN are equipped with low-cost, low-power, short-range radio communication interfaces, for example, supported by well-known wireless communication protocols.

Numerous specific details are set forth to provide a thorough description of various embodiments of the invention. Certain embodiments of the invention may be practiced without these specific details or with some variations in detail. In some instances, features not pertinent to the novelty of the system are described in less detail so as not to obscure other aspects of the invention.

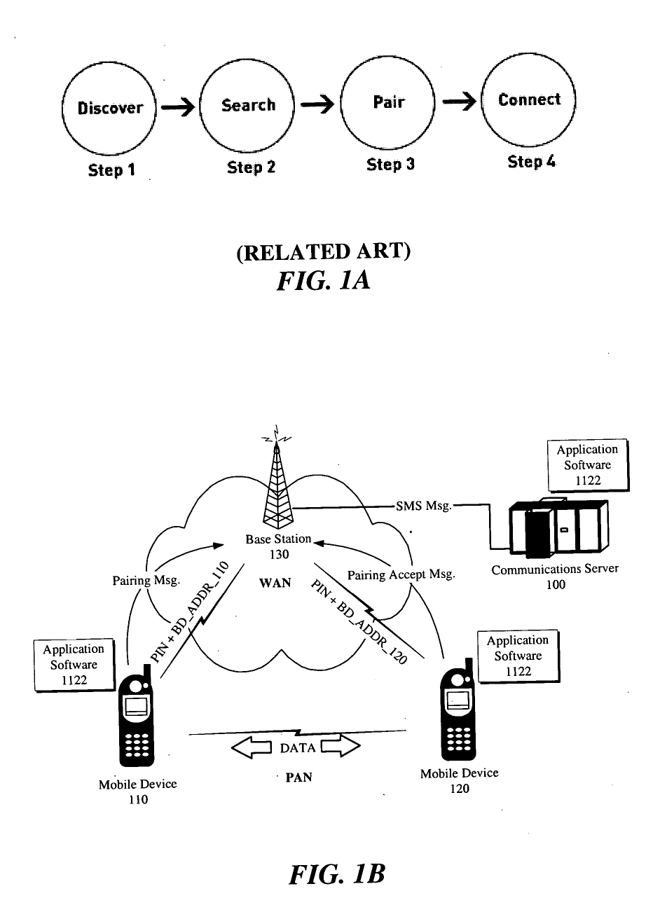

Referring to FIG. 1B, in one or more embodiments of the present invention, Bluetooth technology is applied as a means of wireless communication to pair and connect a plurality of wireless mobile communication devices 110, 120, etc. This application, however, is by way of example.

Other wireless communication technologies suited for connecting wireless devices in short-range area networks, such as IEEE 802.11 and the like may be utilized in other embodiments. The terms “connected,” “coupled,” or any variant thereof, mean any connection or coupling, either direct or indirect, between two or more elements. The coupling or connection between the elements can be physical, logical, or a combination thereof.

One of ordinary skill in the art will appreciate that the communication network of the present invention may advantageously be comprised of one or a combination of various types of networks without detracting from the scope of the invention. Such networks in addition to a PAN can, for example, comprise local area networks (LANs), wide area networks (WANs), public, private or secure networks, value-added networks, interactive television networks, two-way cable networks, satellite networks, interactive kiosk networks, cellular communications networks, personal mobile gateways (PMGs) and/or any other suitable communications network.

In a preferred embodiment, mobile devices 110, 120 communicates with communications server 100, via base station 130, to send and receive electronic packets of information, in form of electronic requests and responses. Some of the services provided by the system of the present invention may be implemented as application software 1122 installed and executed on one or more of mobile devices 110, 120 and/or communications server 100, as provided in further detail below.

Application software 1122 may be installed on individual computing systems or in a distributed environment. In one embodiment, for example, application software 1122 is executed on mobile devices 110, 120 as client software. In other embodiments, application software 1122 may be executed on communications server 1122 as server software, for example.

In either embodiment, application software 1122 is implemented to provide for wireless communication of voice or data among mobile devices 110, 120 and communications server 100. One skilled in the art would appreciate that mobile devices 110, 120 may be substituted with stationary communication devices without detracting from the principals and scope of the invention.

In some embodiments, mobile devices 110, 120 may comprise a PMG device or communicate with a PMG device connected to the communication environment illustrated in FIG. 1B, for example. The PMG architecture comprises a PMG server that can wirelessly communicate with a number of PMG enabled devices within the personal area of the user, or a PAN.

In addition, the PMG server can wirelessly communicate with remote server systems, such as communication server 100, via a wireless system or base station 130 in a WAN. Thus, the PMG acts as an interface to seamlessly connect a PAN to a WAN, and as such the devices attached to the PAN or WAN can communicate with each other. A more detailed description of the PMG architecture is provided in U.S. patent application Ser. No. 09/850,399, filed on May 7, 2001, the entire content of which is hereby incorporated by reference here.

As used herein, the terms mobile device, base station and communications server are to be viewed as designations of one or more computing environments that comprise application, client or server software for servicing requests submitted by respective software included in devices or other computing systems connected thereto. These terms are not to be otherwise limiting in any manner. Application software 1122, for example, may comprise one or more modules that execute on one or more integrated or distributed computing environments.

Referring back to FIG. 1B, in accordance with one embodiment of the invention, mobile device 110 (e.g., a cellular telephone) and mobile device 120 (e.g., a PDA) may be connected in a PAN, when either mobile device 110 or 120 enters a specific range in the proximity of the other device. For a connection to be properly established, an association is implemented between each mobile device 110, 120.

Implementing an association comprises a pairing process after which mobile devices 110 and 120 can securely communicate with each other. When two devices are paired, the devices are synchronized on one or more respective frequency sequences to receive signals from other paired devices at predetermined clocked time intervals.

As provided in more detail below, the association and pairing processes provide for a secure communication environment, where devices can communicate with each other without interfering with other communication sessions in nearby frequency ranges. For additional privacy and security, encryption can be applied to the data carried in the signals communicated between the devices. Thus, in certain embodiments, when the respective association process is implemented, encryption/decryption keys are exchanged between the corresponding devices.

In a preferred embodiment, a personal area wireless network is implemented between mobile devices 110 and 120 by way of a short-range wireless communication protocol, such as Bluetooth, for example. Bluetooth offers fast and reliable digital transmissions of both voice and data over the globally available, unlicensed, 2.4 GHz Industrial, Scientific and Medical (ISM) band.

It is noteworthy that besides Bluetooth, other wireless communication protocols (e.g., IEEE 802.11) may be utilized to establish a communication connection between mobile devices 110 and 120. Bluetooth technology, however, provides on-the-fly ad hoc networks at minimum cost in comparison with the more expensive wired or wireless alternatives. As such, in the following, the invention is described as applicable to a Bluetooth wireless environment, by way of example, without the intent to limit the scope of the invention to the particular details associated with the Bluetooth technology.

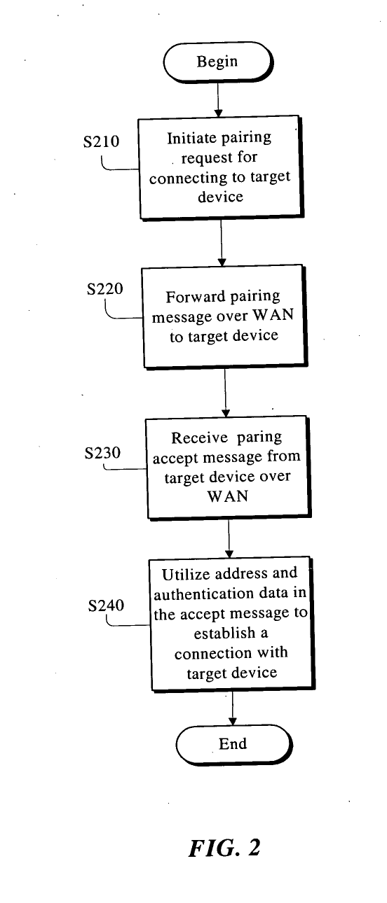

Referring to FIG. 2, in accordance with one embodiment, application software 1122 executed on mobile device 110 initiates a paring request for connecting to mobile device 120 (S210). In a preferred embodiment, the pairing request is submitted in the form of a text message over a short messaging service (SMS) protocol. It is noteworthy that in other embodiments, other forms of messaging may be utilized instead or in combination with SMS to construct and send the pairing request.

SMS is a communication protocol that allows a device with limited editing environment or limited computing power (e.g., a cellular phone) to communicate a simple text message (e.g., 140-160 characters) to an address (e.g., phone number) associated with a target device. Thus, in accordance with one aspect of the invention, a user using mobile device 110 may establish a wireless connection with a mobile device 120 based on mobile device 120's mobile phone number, for example.

To accomplish this, based on input provided by the user, application software 1122 constructs a short text message (i.e., pairing message) to be forwarded to mobile device 120's phone number. The user may provide the corresponding phone number either manually or by, for example, selecting from an automated menu of mobile device 110. Depending on implementation, the phone number may be a 10-digit phone number (e.g., 3-digit area code, 3-digit prefix, and 4-digit number) assigned to mobile device 120 by a service provider such as Sprint, T-Mobile, or other mobile communication service provider.

In one embodiment, the content of the pairing message comprises the device address (e.g., a BD_ADDR) associated with mobile device 110. The device address provides a destination address to which a message intended for mobile device 110 may be forwarded. Application software 1122 may further generate a PIN code associated with the device address for inclusion in the pairing message. The PIN code may be used for authentication purposes when a communication connection is established between mobile devices 110 and 120.

In certain embodiments, application software 1122 may also include an optional pairing policy indicator in the pairing message. The pairing policy indicator provides the intended longevity of the pairing process. For example, it may indicate that the pairing is to have a one-time, time-limited, or semi-permanent life span.

Application software 1122 then forwards the pairing message comprising at least the device address for mobile device 110 (e.g., BD_ADDR_110) to the phone number assigned to mobile device 120 (S220). In an exemplary embodiment, the pairing message is transmitted over the WAN (e.g., a cellular communication network) from mobile device 110 to a base station 130 that monitors the location of mobile devices connected to the WAN.

Accordingly, base station 130 preferably in conjunction with communication server 100 locates mobile device 120 in the wireless communication network and transmits the pairing message to mobile device 120. Upon receipt of the pairing message, application software 1122 executed on mobile device 120 processes the paring message and responds by transmitting an SMS message back to mobile device 110, over the WAN.

If mobile device 120 accepts the pairing request by mobile device 110, then application software 1122 executing on mobile device 120 constructs a pairing accept message comprising a device address (e.g., BD_ADDR_120) associated with mobile device 120. Using mobile device 120's device address, mobile device 110 can establish a local wireless communication connection (e.g., a Bluetooth connection) with mobile device 120.

Application software 1122 running on mobile device 120 may also include in the pairing accept message the PIN code forwarded by mobile device 110, for authentication purposes. Using the PIN code, device 110 can ensure that the pairing accept message has been generated by mobile device 120. In certain embodiments, a public/private key system may be used to encrypt and decrypt the PIN code and/or the device address information included in the respective request and accept messages, to ensure against possible eavesdropping by unauthorized parties.

In accordance with one aspect of the invention, application software 1122 running on mobile device 120 may provide a user of mobile device 120 with the option to accept or reject the pairing message submitted by mobile device 110. In case of a favorable reply, application software 1122 stores mobile device 110's device address (e.g., BD_ADDR_110) and PIN included in the pairing message in a data storage device (e.g., ROM, RAM, flash memory, etc.) of mobile device 120. This information is later used by mobile device 120 for the purpose of establishing a local wireless area connection with mobile device 100.

A pairing accept message generated by mobile device 120 is forwarded to mobile device 110 by way of base station 130, for example. Application software 1122 executing on mobile device 110 receives the paring accept message transmitted from mobile device 120 over the wide area network (S230). In one embodiment, application software 1122 utilizes the information included in the pairing accept message (e.g., BD_ADDR_120 and PIN) to authenticate and establish a wireless connection with mobile device 120 (S240).

Mobile device 110 may receive a paring reject message instead of a pairing accept message or no response at all. If so, mobile device 110 may resubmit another pairing request after a timeout period has expired. If a paring accept message is received, application software 1122 executed on mobile device 110 stores information included in the pairing accept message (e.g., BD_ADDR_120, PIN, etc.) in a data storage device for the purpose of establishing a local wireless area connection with mobile device 120.

As such, during the above noted procedure, mobile devices 110 and 120 exchange a mutual PIN code and device addresses that can be used during a paring or connecting process (e.g., a Bluetooth pairing transaction) between them. One skilled in the art would appreciate that while an exemplary embodiment of the invention is described as applicable to pairing request and accept messages constructed using the SMS communication protocol, other communication protocols such as IP, TCP, or MMS may be used instead to communicate the related information (e.g., device address, PIN code, etc.).

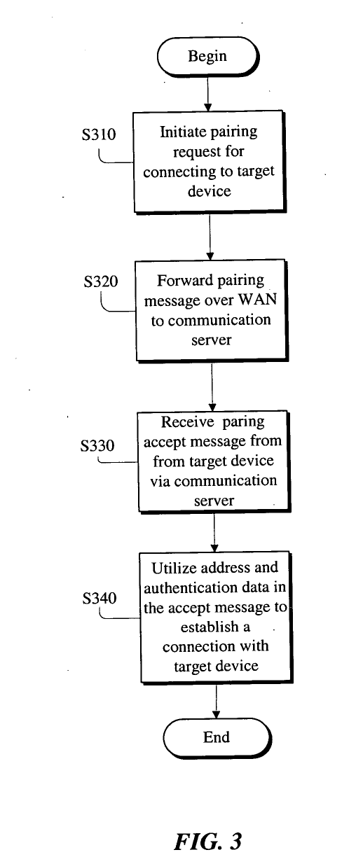

Referring to FIG. 3, in accordance with another exemplary embodiment of the invention, a method for establishing a short-range wireless communication connection between a pair of mobile devices connected in a WAN comprises submitting a pairing request to communication server 100 via a text messaging protocol. In this exemplary embodiment, mobile device 110 may initiate a pairing request for wirelessly connecting to one or more target devices (S310), by forwarding a pairing message to a communication server 100 over a wide area network connection (S320).

The pairing message may be formatted as a text message sent via the SMS protocol, for example, or a similar messaging service suitable for communicating the PIN and device related data. Communication server 100 or a central management system, for example, may be connected to mobile devices 110 and 120 in the WAN as illustrated in FIG. 1B. Communication server 100 processes the pairing message forwarded by mobile device 110 and communicates the related information (e.g., PIN, BD_ADDR_110) to mobile device 120, requesting mobile device 120 to provide a reply.

If the communication server 100 receives a favorable reply (e.g., a pairing accept message) from mobile device 120, then communication server 100 processes the information included in the pairing accept message (e.g., PIN, BD_ADDR_120) and forwards it to mobile device 110 over the wide area network connection in form of a SMS message, for example. Thus, mobile device 110 receives the pairing accept message from mobile device 120 via communication server 100, in accordance with the second embodiment (S330).

Mobile device 110 utilizes devices address and authentication data in the pairing accept message to establish a short-range wireless connection (e.g., a Bluetooth connection) with mobile device 120 (S340). It is noteworthy that in the second exemplary embodiment, the user of mobile device 110 may use a known phone number for mobile device 120 to direct a short text message to mobile device 120. As such, the user will not be required to provide such arcane information as mobile device 120's device address to initiate the pairing process.

In accordance with a preferred embodiment, once the pairing information (e.g., PIN, BD_ADDR, pairing policy, etc.) is exchanged between mobile device 110 and 120, the respective information is stored in a local or remote storage device, from which each device can retrieve said information to establish a short-range communication connection. Once the short-range communication connection (e.g., a Bluetooth connection) is established, then the two mobile devices are able to communicate data.

To establish a short-range communication connection, over a Bluetooth communication protocol, for example, mobile devices 110 and 120 tune their radios to a different frequency, effectively hopping from radio channel to radio channel. This is known as FHSS (Frequency Hopping Spread Spectrum). Thus, if a transmission is compromised by interference on one channel, the retransmission will be on a different channel. Each communication time slot can last approximately 625 μs (625 microseconds), for example, with a hop rate of approximately 1600 hops/second.

Depending on implementation, mobile device 110 can be assigned as a primary device to set the frequency hoping sequence; and mobile device 120 can be assigned as the non-primary device to synchronize with mobile device 110 in time and frequency by following the mobile device 110's frequency hoping sequence. Each device 110 or 120 is associated with a unique Bluetooth device address and a 28-bit Bluetooth clock, for example.

In certain embodiments, the baseband part of the Bluetooth system (incorporated in the primary or non-primary device) uses a special algorithm, which calculates the frequency hop sequence based on the primary devices' clock and device address. In addition to controlling the frequency hop sequence, the primary device controls when non-primary devices are to transmit using Time Division Multiplexing (TDM), in accordance with one or more embodiments.

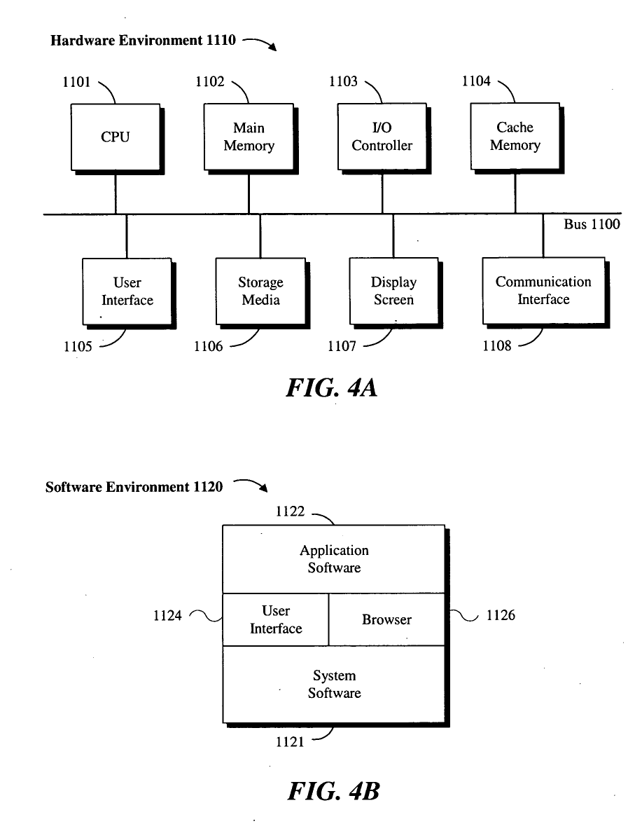

In certain embodiments of the system, communication server 100 and mobile devices 110 and 120 comprise a controlled system environment that can be presented largely in terms of hardware components and software code executed to perform processes that achieve the results contemplated by the system of the present invention. A more detailed description of such system environment is provided below with reference to FIGS. 4A, 4B.

As shown, a computing system environment is composed of two environments, a hardware environment 1110 and a software environment 1120. The hardware environment 1110 comprises the machinery and equipment that provide an execution environment for the software. The software provides the execution instructions for the hardware. It should be noted that certain hardware and software components may be interchangeably implemented in either form, in accordance with different embodiments of the invention.

Software environment 1120 is divided into two major classes comprising system software 1121 and application software 1122. System software 1121 comprises control programs, such as the operating system (OS) and information management systems that instruct the hardware how to function and process information. Application software 1122 is a program that performs a specific task.

In certain embodiments of the invention, system and application software are implemented and executed on one or more hardware environments to establish a short-range communication connection in which mobile devices 110 and 120 can communicate by way of exchanging the requisite device addresses and PINs over a wide area network.

Referring to FIG. 4A, an embodiment of the application software 1122 can be implemented as logic code in the form of computer readable code executed on a general purpose hardware environment 1110 that comprises a central processor unit (CPU) 1101, a main memory 1102, an input/output controller 1103, optional cache memory 1104, a user interface 1105 (e.g., keypad, pointing device, etc.), storage media 1106 (e.g., hard drive, memory, etc.), a display screen 1107, a communication interface 1108 (e.g., a wireless network card, a Bluetooth port, a wireless modem, etc.), and a system synchronizer (e.g., a clock, not shown in FIG. 4A).

Cache memory 1104 is utilized for storing frequently accessed information. A communication mechanism, such as a bi-directional data bus 1100, can be utilized to provide for means of communication between system components. Hardware Environment 1110 is capable of communicating with local or remote systems connected to a wireless communications network (e.g., a PAN or a WAN) through communication interface 1108.

In one or more embodiments, hardware environment 1110 may not include all the above components, or may include additional components for additional functionality or utility. For example, hardware environment 1110 can be a laptop computer or other portable computing device that can send messages and receive data through communication interface 1108. Hardware environment 1110 may also be embodied in an embedded system such as a set-top box, a personal data assistant (PDA), a wireless communication unit (e.g., cellular phone), or other similar hardware platforms that have information processing and/or data storage and communication capabilities. For example, in one or more embodiments of the system, hardware environment 1110 may comprise a PMG unit or an equivalent thereof.

In certain embodiments of the system, communication interface 1108 can send and receive electrical, electromagnetic, or optical signals that carry digital data streams representing various types of information including program code. If communication is established via a communications network, hardware environment 1110 may transmit program code through the network connection. The program code can be executed by central processor unit 1101 or stored in storage media 1106 or other non-volatile storage for later execution.

Program code may be transmitted via a carrier wave or may be embodied in any other form of computer program product. A computer program product comprises a medium configured to store or transport computer readable code or a medium in which computer readable code may be embedded. Some examples of computer program products are memory cards, CD-ROM disks, ROM cards, floppy disks, magnetic tapes, computer hard drives, and network server systems.

In one or more embodiments of the invention, processor 1101 is a microprocessor manufactured by Qualcomm, Texas Instruments, Motorola, Intel, or Sun Microsystems Corporations, for example. The named processors are for the purpose of example. Any other suitable microprocessor, microcontroller, or microcomputer may be utilized.

Referring to FIG. 4B, software environment 1120 or one or more of its components are stored in storage media 1106 and are loaded into memory 1102 prior to execution. Software environment 1120 comprises system software 1121 and application software 1122. Depending on system implementation, certain aspects of software environment 1120 can be loaded on one or more hardware environments 1110.

System software 1121 comprises control software, such as an operating system that controls the low-level operations of hardware environment 1110. Low-level operations comprise the management of the system resources such as memory allocation, file swapping, and other core computing tasks. In one or more embodiments of the invention, the operating system can be Nucleus, Symbian, Microsoft Windows, etc. However, any other suitable operating system may be utilized.

Application software 1122 can comprise one or more computer programs that are executed on top of system software 1121 after being loaded from storage media 1106 into memory 1102. In a client-server architecture, application software 1122 may comprise client software and server software. Referring to FIG. 1B for example, in one embodiment of the invention, client software is executed on mobile devices 110, 120 and server software is executed on communications server 100.

Software environment 1120 may also comprise web browser software 1126 for accessing content on a remote server. Further, software environment 1120 may comprise user interface software 1124 (e.g., a Graphical User Interface (GUI)) for receiving user commands and data. The received commands and data are processed by the software applications that run on the hardware environment 1110. The hardware and software architectures and environments described above are for purposes of example. Other embodiments of the invention may be implemented in any type of system architecture or processing environment.

Some embodiments of the invention are described by way of example as applicable to systems and corresponding methods that utilize Bluetooth communication technology. In this exemplary embodiment, logic code for performing these methods is implemented in the form of, for example, application software 1122. The logic code, in one embodiment, may be comprised of one or more modules that execute on one or more processors in a distributed or non-distributed communication model.

It should also be understood that the programs, modules, processes, methods, and the like, described herein are but exemplary implementations and are not related, or limited, to any particular computer, apparatus, or computer programming language. Rather, various types of general-purpose computing machines or customized devices may be used with logic code implemented in accordance with the teachings provided, herein. Further, the order in which the methods of the present invention are performed is purely illustrative in nature. These methods can be performed in any order or in parallel, unless indicated otherwise in the present disclosure.

The methods of the present invention may be performed in either hardware, software, or any combination thereof. In particular, some methods may be carried out by software, firmware, or macrocode operating on a computer or computers of any type. Furthermore, such software may be transmitted in the form of a computer signal embodied in a carrier wave, and through communication networks by way of Internet portals or websites, for example. Accordingly, the present invention is not limited to any particular platform, unless specifically stated otherwise in the present disclosure.

The present invention has been described above with reference to preferred embodiments. However, those skilled in the art will recognize that changes and modifications may be made in these preferred embodiments without departing from the scope of the present invention. Other system architectures, platforms, and implementations that can support various aspects of the invention may be utilized without departing from the essential characteristics as described herein. These and various other adaptations and combinations of features of the embodiments disclosed are within the scope of the invention. The invention is defined by the claims and their full scope of equivalents.

1. A method for establishing a communication connection with a target device over a short-range wireless communication protocol, the method comprising:
initiating a pairing request for connecting to the target device, the pairing request comprising a unique identification code and a first wireless device address associated with a requesting device; and
forwarding the pairing request in form of a first text message to a phone number associated with the target device over a wide area network, requesting a second wireless device address associated with the target device as authenticated by the unique identification code.

2. The method of claim 1, further comprising:
authenticating a pairing response sent from the target device in form of a second text message to a phone number associated with the requesting device, based on the unique identification code.

3. The method of claim 2, further comprising:
retrieving the second wireless device address from the second text message, if authentication is successful.

4. The method of claim 1, wherein the first text message is forwarded over a short messaging service (SMS) protocol.

5. The method of claim 2, wherein the second text message is forwarded over a short messaging service (SMS) protocol.

6. The method of claim 1, wherein a communication server manages delivery of the pairing request to the target device.

7. The method of claim 2, wherein a communication server manages delivery of the pairing response to the requesting device.

8. The method of claim 3, further comprising:
establishing a connection with the target device over the short-range wireless protocol based on the unique identification code and the first and second wireless device addresses.

9. The method of claim 1, wherein the short-range wireless protocol comprise Bluetooth communication protocol.

10. The method of claim 1, wherein the short-range wireless protocol comprises IEEE 802.11 communication protocol.

11. A system for establishing a communication connection with a target device over a short-range wireless communication protocol, the system comprising:
circuitry for initiating a pairing request for connecting to the target device, the pairing request comprising a unique identification code and a first wireless device address associated with a requesting device; and
circuitry for forwarding the pairing request in form of a first text message to a phone number associated with the target device over a wide area network, requesting a second wireless device address associated with the target device as authenticated by the unique identification code.

12. The system of claim 11, further comprising:
circuitry for authenticating a pairing response sent from the target device in form of a second text message to a phone number associated with the requesting device, based on the unique identification code.

13. The system of claim 12, further comprising:
circuitry for retrieving the second wireless device address from the text message, if authentication is successful.

14. The system of claim 11, wherein the first text message is forwarded over a short messaging service (SMS) protocol.

15. The system of claim 12, wherein the second text message is forwarded over a short messaging service (SMS) protocol.

16. The system of claim 11, wherein a communication server manages delivery of the pairing request to the target device.

17. The system of claim 12, wherein a communication server manages delivery of the pairing response to the requesting device.

18. A method for establishing a communication connection with a target device over a short-range wireless communication protocol, the method comprising:
initiating a pairing request for connecting to the target device, the pairing request comprising a first wireless device address associated with a requesting device; and
forwarding the pairing request to a destination address associated with the target device over a wide area network, requesting a second wireless device address associated with the target device.

19. The method of claim 18, wherein the pairing request comprises a unique identification code, the claim further comprising:
authenticating a pairing response sent from the target device to a destination address associated with the requesting device based on the unique identification code.

20. The method of claim 19, wherein at least one of the pairing request and the pairing response are forwarded over a short messaging service (SMS) protocol.
